(19) United States
(12) Patent Application Publication
(10) Pub. No.: US 2013/0045416 A1
(43) Pub. Date: Feb. 21, 2013

(54) GOLD MICRO- AND NANOTUBES, THEIR SYNTHESIS AND USE

(71) Applicants: Dwight S. SEFEROS, Mississauga (CA); Colin BRIDGES, Toronto (CA); Paul DICARMINE, Toronto (CA)

(72) Inventors: Dwight S. SEFEROS, Mississauga (CA); Colin BRIDGES, Toronto (CA); Paul DICARMINE, Toronto (CA)

(73) Assignee: THE GOVERNING COUNCIL OF THE UNIVERSITY OF TORONTO

(21) Appl. No.: 13/586,511

(22) Filed: Aug. 15, 2012

Related U.S. Application Data
(60) Provisional application No. 61/523,700, filed on Aug. 15, 2011.

(51) Int. Cl. C25D 1/02; H01G 9/00; G01N 27/26; C22C 5/02; B32B 1/08; H01M 4/02; H01B 1/22; G01J 3/42; G01N 27/30; B82Y 40/00

(52) U.S. Cl. 429/209; 356/402; 361/500; 205/73; 205/792; 204/400; 428/546; 428/376; 252/514; 977/893; 977/734

(57) ABSTRACT

Synthesis of gold microtubes and nanotubes suspendable in solution is presented. The synthesis is accomplished using an AAO template route, wherein a polymer tube is used as a sacrificial core. The synthesis produces hollow structures that consist of only gold. These nanostructures exhibit two SPR modes, which correspond to both the transverse and longitudinal modes. The mode assignment was confirmed by measuring SPR behavior as both aligned arrays and in solution. The performance of gold nanotubes as refractive index detectors was quantified and determined to be more sensitive than analogous solid nanorods prepared under identical conditions, and are among the most sensitive nanostructured plasmon sensors to date. Due to their intense and sensitive resonances in the NIR spectrum, these solution-suspendable nanoparticles have potential to be used as in vitro or in vivo sensors.

### CROSS-REFERENCE TO RELATED U.S. APPLICATION

This patent application relates to, and claims the priority benefit from, U.S. Provisional Patent Application Ser. No. 61/523,700 filed Aug. 15, 2011 entitled Solution Suspendable Gold Nanotubes, and which is incorporated herein by reference.

### FIELD OF THE INVENTION

The present invention relates to gold tubes, particularly nanotubes and microtubes, and methods of making them.

### BACKGROUND

Just as photons are the quantum particles of light and phonons are the quantum particles of sound, plasmons are the quantum particles of waves of plasma (i.e. free electron gas). Whereas photons represent oscillations of electromagnetic fields and phonons represent mechanical oscillations in material media, plasmons represent oscillations of free electron gas density. Surface plasmons are electron waves that exist along an interface between two media with differing electromagnetic properties; surface plasmons propagate in a direction parallel to the interface. Generally speaking, surface plasmons can exist on a metal-dielectric interface, such as the surface of a metal sheet in air.

Surface plasmon resonance (SPR) is the excitation of surface plasmons by photons. SPR generally occurs when light is incident on an interface that can sustain plasma oscillations. This coupling of photons with plasmons can propagate self-sustainably along e.g. a metal-dielectric interface. Such coupled photon-plasmon interactions may also be termed surface plasmon polaritons. Noble metal nanostructures are generally capable of exhibiting SPR under illumination. On the scale of such nanostructures, direct illumination causes a coherent oscillation of conduction electrons (also known as localised surface plasmon resonance (LSPR)), resulting in a charge build up with a distinct restoring force corresponding to a resonance peak. This SPR peak is highly dependent on nanostructure size, shape, and the dielectric properties of the surrounding medium. Noble metal nanostructures whose dimensions approach the penetration depth of light in metals (about 50 nm) have optical properties that are highly dependent on size, shape and environment. As such, nanostructures exhibiting SPR have enormous utility as e.g. optical sensors, since changes in the environment of the nanostructure can manifest themselves as changes in the SPR properties of the nanostructure. As such, there is great interest in characterizing SPR properties in new materials, since SPR-based devices are emerging for use in subwavelength optics, photovoltaics, and ultra-sensitive optical sensors.

The index sensitivity of SPR extends approximately 5-10 nm from the surface of metal nanostructure. This localized sensitivity is especially interesting for optical sensing, because nanostructures can be functionalized with molecules that bind analytes, causing a local change in refractive index, thus shifting the SPR peak of the nanostructre. Resonances in the red to near infrared (NIR) range (about 800 nm to about 1300 nm) are desirable since they are more sensitive to refractive index change. Wavelengths in this range also lie in the so-called “water window” and are transmitted through both water and human tissues. Solution-suspendable nanostructures with SPR peaks in this range open intriguing possibilities for in vivo and in vitro plasmonic biosensing.

A variety of plasmonic nanoparticles and nanostructures have been devised for use in SPR-based sensing. Solution-based synthesis have been successful in controlling the shape of nanoparticles, creating complex solid shapes such as stars, prisms, and more complicated assemblies of spheres or rods. However, hollow nanostructures with high surface-area-to-volume ratios are advantageous since plasmons are confined to the surface of particles, since they exhibit less dampening of the plasmon oscillation. This results in stronger signals, leading to more efficient plasmon generation, and increases the detection limits of plasmon sensors. However, hollow plasmonic nanostructures are rare by comparison due to the difficulties inherent in their synthesis using solely solution-based methods, though nanostructural rings, shells and cages, have been reported for use as plasmonic devices.

Electron-beam lithography is an alternative to solution-based synthesis, and has been used to create and study surface-bound plasmonic nanostructures with complex geometries. For example, hollow gold nanotubes bound to a substrate have been synthesized by the Whitesides (“Core-Shell and Segmented Polymer-Metal Composite Nanostructures”, Lahav, M., Weiss, E., Xu, Q., and Whitesides, G. M., Nano Letters, 2006, 6, 2166-2171) and Pollard (“High-performance Biosensing using Arrays of Plasmonic Nanotubes”, J. McPhillips, A. Murphy, M. P. Jonsson, W. R. Hendren, R. Atkinson, F. Höök, A. Zayats and R. Pollard, ACS Nano 2010, 4, 2210-2216) groups.

Whitesides discloses composite nanostructures (200 nm wide and several micrometers long) of metal and polyaniline (PANI) in two new variations of core-shell (PANI-Au) and segmented (Au-PANI and Ni—Au-PANI) architectures, fabricated electrochemically within anodized aluminum oxide (AAO) membranes. Control over the structure of these composites (including the length of the gold shells in the core-shell structures) was accomplished by adjusting the time and rate of electrodeposition and the pH of the solution from which the materials were grown. Exposure of the core-shell structures to oxygen plasma removed the PANI and yielded aligned gold nanotubes bound to a substrate. In the segmented structures, a self-assembled monolayer (SAM) of thioaniline nucleated the growth of PANI on top of metal nanorods and acted as an adhesion layer between the metal and PANI components.

Pollard discloses that aligned gold nanotube arrays bound to a surface capable of supporting plasmonic resonances can be used as high performance refractive index sensors in biomolecular binding reactions. Pollard also presents a methodology to examine the sensing ability of the inside and outside walls of the nanotube structures. The sensitivity of the plasmonic nanotubes is found to increase as the nanotube walls are exposed, and the sensing characteristic of the inside and outside walls is shown to be different. Finite element simulations showed good qualitative agreement with the observed behavior. Free standing gold nanotubes displayed bulk sensitivities in the region of 250 nm per refractive index unit and a signal-to-noise ratio better than 1000 upon protein binding which is highly competitive with state-of-the-art label-free sensors.

However, these syntheses result in nanotubes that are bound to a substrate, and cannot be suspended in solution. Moreover, the homogenous SPR properties of such surface-bound hollow nanostructures cannot be determined, and thus these compositions cannot be used for homogeneous detection or sensing.

### SUMMARY

Herein are disclosed a gold microtubes and gold nanotubes, including suspendable gold nanotubes or mictotubes capable of existing in a suspension in a solution, said tubes being not bound to a surface or a substrate. The tube has an outer diameter in the range of from about 1 nm to about 3000 nm.

Herein is also disclosed a method for synthesizing a suspendable gold nanotube or microtube, said method comprising

a) forming an electrical contact on a side of a template, said template having a pore;

b) depositing a first material within said pore;

c) polymerizing a hydrophobic polymer within said pore to form a polymer core;

d) collapsing said polymer core;

e) depositing a gold shell around said polymer core; and

f) removing said first material, said hydrophobic polymer, and said template to produce said suspendable gold tube.

Further, herein is disclosed a method for detecting the presence of a biomolecule in a solution, said method comprising the steps of

a) synthesizing a suspendable gold nanotube, said suspendable gold nanotube having a binder attached thereto, said binder capable of binding to said biomolecule;

b) measuring a first extinction spectrum of said suspendable gold nanotube;

c) suspending said suspendable gold nanotube in said solution in which said biomolecules may or may not be present;

d) measuring a second extinction spectrum of said suspendable gold nanotube; and

e) determining the change between said first and second extinction spectra;

wherein a substantial change between said first and second extinction spectra indicates the presence of said biomolecule in said solution.

A further understanding of the functional and advantageous aspects of certain embodiments of the invention can be realized by reference to the following detailed description and drawings.

### BRIEF DESCRIPTION OF THE DRAWINGS

Embodiments will now be described, by way of example only, reference being made to the accompanying drawings, in which:

FIG. 1 is a scheme depicting an exemplary gold nanotube synthesis (only half of the template is only shown for clarity).

FIG. 2 is a graph showing the extinction spectra of gold nanotubes that are 55±7 nm in diameter and aligned in an AAO template.

FIG. 3 is a graph showing the extinction spectra of gold nanotubes (previously containing poly(3-hexyl)thiophene cores) suspended in D₂O (Length=258+/−42 nm, Width=55+/−7 nm), accompanied by their TEM (A) and SEM (B) images. All scale bars are 100 nm.

FIG. 4 is a graph showing the extinction spectra of gold nanotubes suspended in increasing concentrations of glycerol in D₂O.

FIG. 5 is a series of graphs showing the refractive index testing of gold nanorods (A) and gold nanotubes (B) immersed in increasing concentrations of glycerol/D₂O. (C) is a graph showing the refractive index sensitivity plots comparing the transverse and longitudinal modes of nanorods and nanotubes.

FIG. 6 is a graph showing the extinction spectra of DNA functionalized gold nanotubes prior and post addition of the complementary DNA strand.

### DETAILED DESCRIPTION

Various embodiments and aspects of the disclosure will be described with reference to details discussed below. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosure.

As used herein, the terms, “comprises” and “comprising” are to be construed as being inclusive and open ended, and not exclusive. Specifically, when used in this specification including claims, the terms, “comprises” and “comprising” and variations thereof mean the specified features, steps or components are included. These terms are not to be interpreted to exclude the presence of other features, steps or components.

As used herein, the term “exemplary” means “serving as an example, instance, or illustration,” and should not be construed as preferred or advantageous over other configurations disclosed herein.

As used herein, the terms “about” and “approximately”, when used in conjunction with ranges of dimensions of particles, compositions of mixtures or other physical properties or characteristics, are meant to cover slight variations that may exist in the upper and lower limits of the ranges of dimensions so as to not exclude embodiments where on average most of the dimensions are satisfied but where statistically dimensions may exist outside this region. It is not the intention to exclude embodiments such as these from the present disclosure.

As used herein, the term “suspendable”, when used in conjunction with nanotubes or nanoparticles or microtubes, means that the particles are capable of existing in a suspension in a solution. A suspendable nanoparticle is one, therefore, that is not bound to a surface or a substrate, and is free to exist in a suspension in a solution.

As used herein, the term “nanoparticle” means a particle having at least one dimension within the range of about 1 nm to about 3000 nm.

As used herein, the term “nanotube” means a substantially cylindrical nanoparticle having a hole extending longitudinally therethrough. The cross-section of the hole may vary throughout the length of nanoparticle. Nanostructures are typically considered to be structures dimensioned in nanometers. Tubes of the invention encompass what are often called nanotubes, tubes having an outer diameter of up to about 1000 nm, and tubes having an outer diameter of up to about 3000 nm, i.e. tubes that would often be considered microtubes.

In an aspect, a method for synthesizing a gold tube is disclosed. The method includes steps a) to d): step a) includes providing a template that includes a mold and an electrode. The mold has a pore therethrough and the electrode has a first layer that is an electrically conductive contact surface at a first end of the pore. The first layer is made up of a material that is sacrificial i.e., it is removed after the tube is formed. It is within this pore that the tube is ultimately formed. In step b), a polymer precursor is electropolymerized to form a polymer core. The core thus forms by polymerizing from the contact surface and grows toward the other end of the pore. Polymer precursor(s) are those that polymerize in a manner that polymer core formed has a void in its interior. Preferably, the void runs along most or all of the length of the polymer core that is formed. In step c), conditions are applied to the core to cause the polymer of the core wall to contract and the outer wall collapses inwardly toward the void. The collapsing leads to a cavity being defined between the outer wall of the core and the wall of the pore. Step d) involves introducing a gold plating solution into the cavity and growing a gold tube from the contact surface upwardly within the cavity toward the opposite end of the pore.

To obtain a suspendable tube or a tube free of a supporting substrate, sacrificial materials are removed and the tube formed within the mold is released.

A tube in the context of the invention is a nanotube or a microtube having an outer diameter of up to 3000 nm. An outer diameter of a microtube may be up to 2500 nm, 2000 nm, 1500 nm, or about 1000 nm. Nanotubes of the invention have an outer diameter of between about 1 nm and 1000 nm. The desired dimensions of a tube can be determined according to the ultimate use of the tube, certain properties of the tubes varying with length, width and/or wall thickness as described elsewhere. Examples of outer diameters of a nanotube are in the range of from 1 to 900, 1 to 800, 5 to 900, 10 to 800, 10 to 700, 10 to 600, 10 to 500, 10 to 400, 10 to 300, 10 to 200, 10 to 150, 10 to 140, 10 to 130, 10 to 120, 10 to 110, 10 to 100, 20 to 500, 20 to 400, 20 to 300, 20 to 200, 20 to 150, 30 to 500, 30 to 400, 30 to 300, to 200, 30 to 150, 30 to 100, 40 to 500, 40 to 400, 40 to 300, 40 to 200, 40 to 150, 40 to 100, 50 to 100, or about 2, 3, 4, 5, 10, 15, 20, 25, 30, 35, 40, 45, 50, 55, 60, 65, 70, 75, 80, 85, 90, 100 or 110 nm. The thickness of the tube wall can be up to about 499 nm and can be between about 1 nm and 499, 1 and 400, 1 and 300, 1 and 200, 1 and 100, 1 and 80, 1 and 50, 1 and 40, 1 and 30, 1 and 20, 1 and 10, 2 and 100, 2 and 80, 2 and 50, 2 and 40, 2 and 30, 2 and 20, 2 and 10, 5 and 100, 5 and 80, 5 and 50, 5 and 40, 5 and 30, 5 and 20, 5 and 10, 10 and 100, 10 and 80, and 50, 10 and 40, 10 and 30, or 10 and 20 nm. Dimensions of a mold, polymer core, growth conditions etc. can be varied to obtain nanotubes and/or microtubes of desired dimensions or range of dimensions, and shapes.

Length of the gold tube can be up to 10,000 nm, can be between 1 and 10,000 nm, 1 and 5,000, 1 and 2,000, 1 and 1,000, 1 and 500, 1 and 400, 1 and 300, 1 and 200, 1 and 100, 1 and 50, 5 and 10,000 nm, 5 and 5,000, 5 and 2,000, 5 and 1,000, 5 and 500, 5 and 400, 5 and 300, 5 and 200, 5 and 100, 5 and 50, 20 and 10,000 nm, 20 and 5,000, 20 and 2,000, 20 and 1,000, 20 and 500, 20 and 400, 20 and 300, 20 and 200, 20 and 100, 20 and 50, 30 and 10,000 nm, 30 and 5,000, 30 and 2,000, 30 and 1,000, 30 and 500, 30 and 400, 30 and 300, 30 and 200, 30 and 100, 30 and 50, 50 and 10,000 nm, 50 and 5,000, 50 and 2,000, 50 and 1,000, 50 and 500, 50 and 400, 50 and 300, 50 and 250, 50 and 200, 50 and 100 nm.

Tubes, particularly nano- or microtubes of the invention have an aspect ratio of greater than 1, and up to 1000, and typically in the range from 2 to 50. In particular applications, other aspect ratios may be desirable, and gold tubes having aspect ratios of at least e.g., 2, 5, 10, 20, 30, 40, 50, 60, 100, 150, 200, 250, 300, 400, 500, or 600 are possible.

Descriptions of ranges are intended to include sub-ranges encompassed by the explicitly disclosed ranges. For example, the disclosure of ranges 2 to 100 and 5 to 150 is intended as a disclosure of the ranges 2 to 150 and 5 to 100 as those these were also explicitly written.

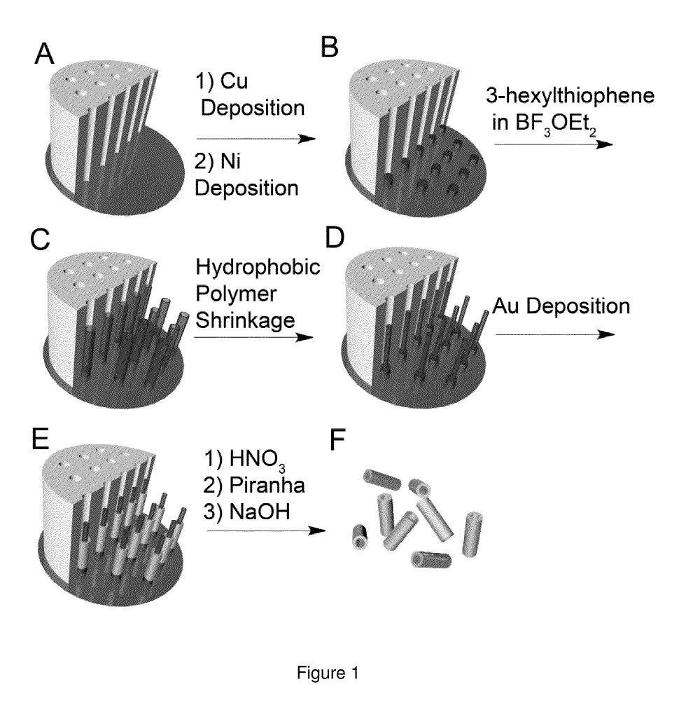

In the example, a mold comprises a film of AAO and the pores extend through the film. The electrode is located on one side of the film, notionally the lower side of the AAO film as the mold is oriented in FIG. 1. Polymers are formed by electropolymerization and grow within a pore toward the upper side of the membrane. The polymer formed is hydrophobic so tends to avoid contact with the AAO and does not adhere to the AAO as it grows within the pore. Hydrophobicity of a polymer in this context can be determined by determining the water contact angle (WCA) of the polymer. WCA can be measured for a film of a polymer, for example, as known in the art, by the Sessile Drop method using a contact angle meter at 23° at 33% relative humidity. It has been found that the WCA should be greater than about 70°, but can be greater than 75°, or greater than 80°, or greater than 85°, or greater than 90°, or greater than 95°, or greater than 100°, or greater than 105°, or greater than 110°, or between 70° and 110°, or between 75° and 100°, or about 70°, 75°, 80°, 85°, 90°, 95°, 110°, 115°, 120° or 130°. It has also been found that polymers whose films have a WCA greater than about 70° can form into the desired tube-like shape as they grow within a pore, i.e., form with an internal void. This permits the polymer of the core to contract when dried after core formation, which results in the collapsing of the core wall radially inwardly toward the void within the core. A mold cavity is thus defined between the outer wall of the polymer core and the inner wall of the pore, and the shape of the subsequently formed gold tube, be it a nanotube or microtube, is thereby established.

Examples of polymers that can make up the polymer core are poly(3-(C₁-C₃₀-alkylthiophene), poly(3,4-ethylenedioxythiophene), poly(3,4-methylenedioxythiophene), poly(3,4-propylenedioxythiophene), poly(3,4-dimethoxyoxythiophene), poly(3-hexylthiophene), polyphenylene, polythiophene, poly-3-methylthiophene, polyethylene, polystyrene, polymethylmethacrylate, polyisoprene, or polypropylene. The water contact angles of unsubstituted thiophene films are around 80-90° and increase to −110° for alkyl substituted thiophene films. In this context, C₁-C₃₀-alkyl includes straight-chain or branched hydrocarbon groups.

AAO is an example of sacrificial material of which a mold may be made. AAO remains essentially intact during the steps of core formation, core collapse and tube formation as through the electroplating process of the example. As illustrated in the example, AAO can be chemically degraded under basic conditions that leave the gold tube structurally intact.

It is possible using the methods described herein for the mold cavity formed in step c) to be sufficiently wide to permit the step of forming the tube within the cavity. It is thus possible for step d) to be conducted subsequent to step c) without widening of the pore by etching of the pore walls, e.g., exposing the AAO of the example to basic etching conditions between steps c) and d).

Other materials suitable for the mold are track-etched polycarbonate, track-etched polyester, mica, porous silica, porous metal oxides, and porous metals.

A tube obtained by the specific example described herein have a generally circular outer cross-section, and has a central passage therethrough resulting in a generally annular cross-section. The passage of the tube extends from end to end i.e., the tube is open at both ends so the interior of the tube is in communication with its surrounding environment. The outer cross-section of a tube comes from the shape of the pore wall in the mold in which the tube is formed, so differently shaped pore walls lead to tubes having a differently shaped outer cross-sections.

The template of step a) presents a conductive surface for electropolymerization of the core and deposition of the gold tube. This first layer, as illustrated in the example, can be nickel, but other suitable materials are copper, platinum, palladium, iron, manganese, titanium, titanium oxide, chromium, chromium oxide, zinc, zinc oxide, indium, tin, indium tin oxide, cadmium, selenium, tellurium, germanium, rhodium, ruthenium, iridium, calcium, aluminum, or an oxide of any of the foregoing.

In the example, the working electrode is provided by a silver layer that was deposited on the lower side of the membrane (as oriented in FIG. 1), and a layer of copper was deposited on the silver at the bottom end of the pore with the nickel that provided the contact surface in the example being deposited on the copper layer. So in the embodiment of the example, a first layer or upper layer is provided by nickel, a working electrode or second layer is provided by silver and an intervening layer provided by copper, the intermediate layer being in direct physical and electrical contact with the upper and lower layers. The intervening layer, different from the upper layer, can be nickel, copper, platinum, palladium, iron, manganese, titanium, titanium oxide, chromium, chromium oxide, zinc, zinc oxide, indium, tin, indium tin oxide, cadmium, selenium, tellurium, germanium, rhodium, ruthenium, iridium, calcium, aluminum, or an oxide of any of the foregoing.

In the example, step a) thus includes installing the electrode on the mold by depositing silver on a side of the membrane to be at one end of a pore that extends through the membrane, depositing copper on the surface of the silver interior of the pore defined by the mold and depositing nickel on the copper. Other ways for providing a template that is made up of a mold having a pore therethrough and an electrode are known to the skilled person.

In the example, the template i.e., mold and electrode components and the polymer core are sacrificial materials that are chemically degraded so that the gold nanotubes formed are released and can be suspended in solution, or otherwise isolated. In the example, the template containing the nanotubes are exposed to nitric acid solution which degrades the silver, copper and nickel layers. The polymer core is degraded by acid in the presence of the oxidizing agent hydrogen peroxide, specifically piranha solution. The mold material, AAO degraded in a basic solution.

Using the methods described herein it is possible to produce a gold tube free of a supporting metal substrate, and having an outer diameter of between 1 nm and 2500 nm.

The tube can be produced with a wall defines an open passage from end to end of the tube. The tube can be a microtube or a nanotube having selected dimensions i.e., outer diameter and wall thickness, and tube length. In particular embodiments, the outer diameter is between 40 and 200 nm, or up to 100 nm and the wall thickness is between about 1 to 100 nm. The tube can have a length in the range of from 1 nm to 10,000 nm, more likely up to about 1000 nm.

In embodiments, the tube has a length of between 50 and 250 nm and an optical extinction peak in the range of about 800 nm to about 2000. A composition comprising a suspension of such nanotubes in water can have a surface plasmon resonance peak in a range about 1000 nm/RIU to about 2000 nm/RIU.

In embodiments, a tube can have bound a binder bound to the wall of the tube. In preferred embodiments, the binder is capable of binding to a biomolecule. Such a biomolecule can be a nucleic acid molecule, a lipid, a polypeptide and a protein, a DNA, RNA, aptamer or antibody. Where the biomolecule is a DNA strand, for example, the binder can be a DNA strand that has a complementary base sequence to the binder.

Such nanotubes can be useful in the detection of biomolecules i.e., where the tube has a first surface plasmon resonance peak when the biomolecule is not bound to the binder and the tube has a second surface plasmon resonance peak when the biomolecule is bound to the binder and the second surface plasmon resonance peak is distinct from said first surface plasmon resonance peak.

In embodiments, a composition comprises a plurality of gold tubes wherein each of the tubes is detached from the others, as in a suspension of gold nanotubes.

In another aspect, the invention includes a method for determining the presence of a biomolecule in a solution, the method comprising:

measuring a first extinction spectrum of a gold nanotube having a binder bound thereto suspended in the solution to obtain a first extinction spectrum, wherein the binder binds to the biomolecule when present; and

comparing the first extinction spectrum to a second extinction spectrum of the nanotube, the second extinction spectrum being determined in the absence of the biomolecule,

wherein a substantial difference between the first and second extinction spectra indicates the presence of said biomolecule in said solution.

The method can include ultrasonicating the solution prior to the step of measuring the first extinction spectrum to preclude aggregation of said suspendable gold nanotube.

In another embodiment, the invention is a method for determining the presence of a biomolecule in a solution, the method comprising:

measuring a first electronic signature of a gold nanotube having a binder bound thereto suspended in the solution to obtain a first electronic signature, wherein the binder binds to the biomolecule when present; and

comparing the first electronic signature to a second electronic signature of the nanotube, the second electronic signature being determined in the absence of the biomolecule,

wherein a substantial difference between the first and second electronic signatures indicates the presence of said biomolecule in said solution.

In another aspect, the invention is electrochemical sensor having an electrode in which the electrode contains a gold nanotube or microtube.

In another aspect, the invention is a battery electrode containing a gold nanotube or microtube.

In another aspect, the invention is an electrochemical capacitor containing an electrode containing a gold nanotube or microtube.

Herein are presented suspendable gold nanotubes and the methods for the synthesis thereof. As contrasted with substrate-bound gold nanotubes, the solution-based SPR properties and refractive index sensitivity of suspendable gold nanotubes can be measured and studied.

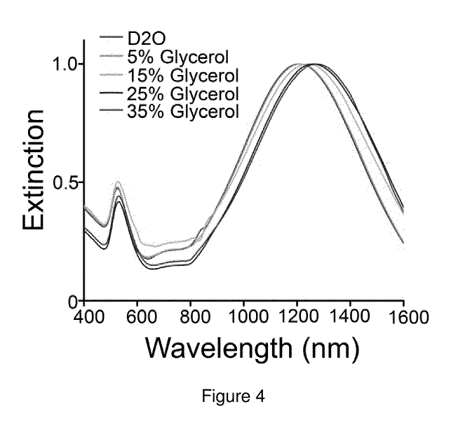

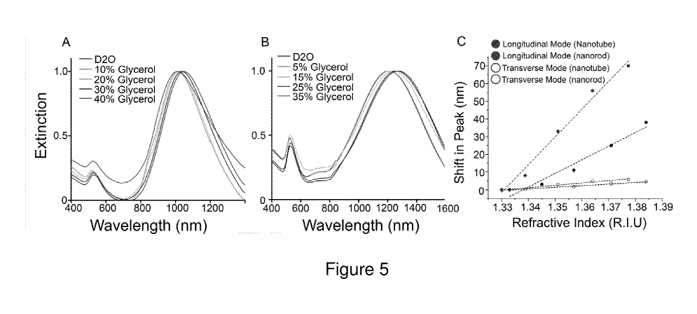

The novel nanostructures disclosed herein can be used as homogenous detectors. The longitudinal mode of gold nanotubes is extraordinarily sensitive to changes in refractive index, and nanotubes are among the most sensitive soluble nanostructures ever observed. It should be noted that in control experiments, both the transverse and longitudinal modes of hollow gold nanotubes outperformed solid gold nanorods as refractive index sensors. Overall, these results indicate that hollow nanomaterials, rather than solid particles are a better choice if sensitive homogeneous detection is required. To determine the sensitivity of gold nanotubes as plasmonic detectors, the change in SPR resonance (Δ nm) was measured as a function of the change of the refractive index of the media. According to convention, the later value is expressed in terms of refractive index units (RIU). Extinction spectra were recorded for nanotubes suspended in D₂O solutions of gradually increasing glycerol content; 0-35 wt % (FIG. 4). The sensitivity of both the transverse and longitudinal peak of the gold nanotubes was compared using the standard nm/RIU metric. It is known that increasing the aspect ratio of nanoparticles red-shifts their SPR peak as well as increases their sensitivity to RIU. As such, it is expected that the longitudinal mode of nanotubes be more sensitive than the transverse mode. For the disclosed gold nanotubes, the sensitivity of the longitudinal mode may be in the range of about 1000 nm/RIU to about 2000 nm/RIU. The sensitivity of the transverse mode of the transverse mode may be in the range of about 100 nm/RIU to about 500 nm/RIU. Indeed, it was observed for a particular embodiment that the sensitivity of the longitudinal mode is 1568 nm/RIU, significantly more sensitive to change in refractive index than the transverse mode (134 nm/RIU; FIG. 5). The sensitivity of the disclosed gold nanotubes greatly surpasses the sensitivity of prior art gold nanorods.

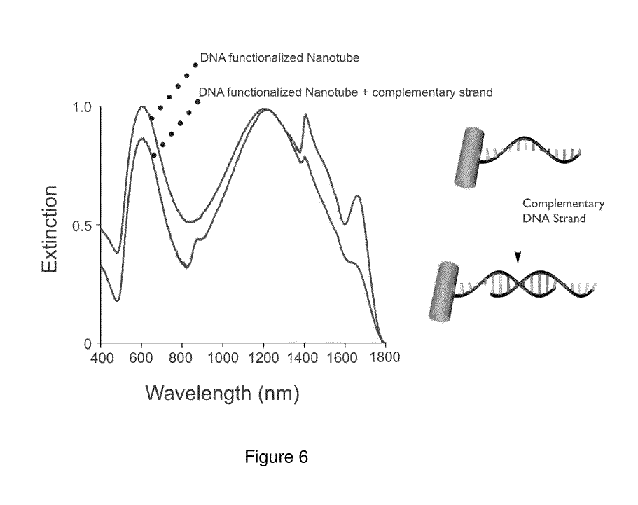

Given the sensitivity of the gold nanotubes disclosed herein, they can be used as novel biosensors. Biomolecules of interest (or analytes) can be detected by attaching functional groups (or binders) to the nanotubes that bind these biomolecules; upon binding to the nanotubes, these biomolecules alter the SPR properties of the nanotubes. The gold nanotubes described herein can be functionalized with a variety of functional groups (or binders) for the purpose of detection, including, but not limited to oligonucleotides, DNAs, RNAs, aptamers, antibodies, lipids, proteins, peptides, or a molecule or materials capable of binding oligonucleotides, DNAs, RNAs, aptamers, antibodies, lipids, proteins, or peptides, or any other molecule or material capable of binding an analyte. In a certain embodiment, the gold nanotubes disclosed herein were modified to act as novel DNA sensors. The gold nanotubes were functionalized with Thiol-modified DNA. A solution containing the complementary DNA strand was introduced to the nanotube suspension, and the extinction spectra was recorded for the DNA functionalized nanotubes both prior and post addition of the complementary strand (FIG. 6). In this particular embodiment, an optical shift of 10 nm was observed in the longitudinal mode, while no shift is observed for the transverse mode, showing the longitudinal mode is capable of detecting surface binding events with greater sensitivity than the transverse mode. Though in this example the gold nanotubes are configured to detect solely the presence of a single strand of DNA, a person skilled in the art will appreciate that they may be functionalized to detect a variety of biomolecules.

Given the nanoscale dimensions of the materials, and their electronic conductivity, this invention can also be used as the electrode materials in an electrochemical sensor device. One skilled in the art can attach a biomolecular recognition element to the surface and observe a change in electronic properties upon analyte binding. Biomolecules of interest (or analytes) can be detected by attaching functional groups (or binders) to the nanotubes that bind these biomolecules; upon binding to the nanotubes, these biomolecules alter the electronic properties of the nanotubes. The gold nanotubes described herein can be functionalized with a variety of functional groups (or binders) for the purpose of detection, including, but not limited to oligonucleotides, DNAs, RNAs, aptamers, antibodies, lipids, proteins, peptides, or a molecule or materials capable of binding oligonucleotides, DNAs, RNAs, aptamers, antibodies, lipids, proteins, or peptides, or any other molecule or material capable of binding an analyte.

Given the nanoscale dimensions of the materials, and their electronic conductivity, this invention can also be used as the electrode material in an electrochemical storage device. High surface area and tubular structure makes these materials especially useful for supercapacitors. Supercapacitor materials can be constructed from gold nanotubes and any material that is capable of storing charge such as a conductive polymer, especially polyaniline, polypyrrole, thiophene, poly(3,4-ethylenedioxythiophene); a metal oxide, especially MnO₂, TiO₂, V₂O₅, Fe₃O₄ and Fe₂O₃; or a carbon-based material, especially a carbide, a carbon nanotube, graphene, fullerene or a carbon organic framework. They may also be used as the electrode materials in a battery, especially a polymer ion battery.

The synthesis of the suspendable gold nanotubes (FIG. 1) is accomplished by the sequential deposition of materials in a template. In one embodiment, the template was an anodized aluminum oxide template (AAO). Other materials can be used as a template including, but not limited to, track-etched polycarbonate, track-etched polyester, mica, porous silica, porous metal oxides, porous metals, and any other membrane that posses a regular or irregular array of pores. The synthesis involves the deposition of sacrificial metal base materials, electropolymerization to form a sacrificial hydrophobic polymer core, core collapse by hydrophobic effects, the deposition of a gold shell, and the removal of all sacrificial materials. FIG. 1 shows a scheme for the synthesis of the suspendable gold nanotubes. In a particular embodiment, the AAO template, which has a plurality of pores, is coated with silver on one side to form an electrical contact (Step A of FIG. 1). Other materials can be used as a contact including, but not limited to, gold, platinum, palladium, copper, indium, indium tin oxide, silicon, silicon oxide, or any other conductive material that can be coated onto a porous membrane. Copper followed by nickel are electrodeposited within the pores (Step B of FIG. 1). Instead of copper and nickel, other metals and metal oxides may be equivalently used including, but not limited to, platinum, palladium, iron, manganese, titanium, titanium oxide, chromium, chromium oxide, zinc, zinc oxide, indium, tin, indium tin oxide, cadmium, selenium, tellurium, germanium, rhodium, ruthenium, iridium, calcium, aluminum or any metal or metal oxide that can be deposited into a porous membrane. 3-hexylthiophene is electropolymerized, which acts as a core for directing gold nanotube growth (Step C). Other polymers can be used as a core including, but not limited to, polyphenylene, polythiophene, poly-3-methylthiophene, polyethylene, polystyrene, polymethylmethacrylate, polyisoprene, polypropylene, or any other polymer that can be deposited into a porous membrane. The polymer core collapses due to hydrophobic interactions (Step D). A gold shell is electrodeposited around the polymer core (Step E). The Cu, Ni and Ag layers, polymer core and template are etched to yield hollow gold nanotubes (Step F).

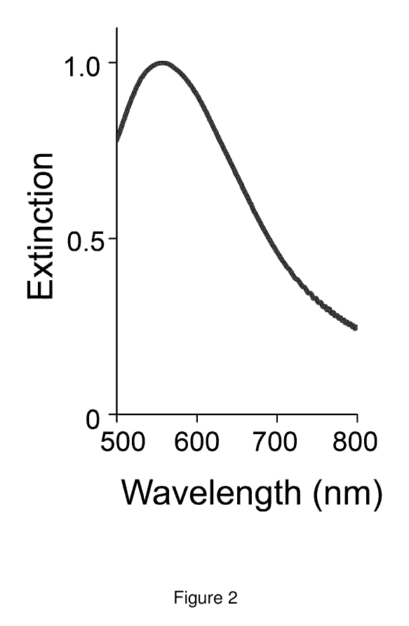

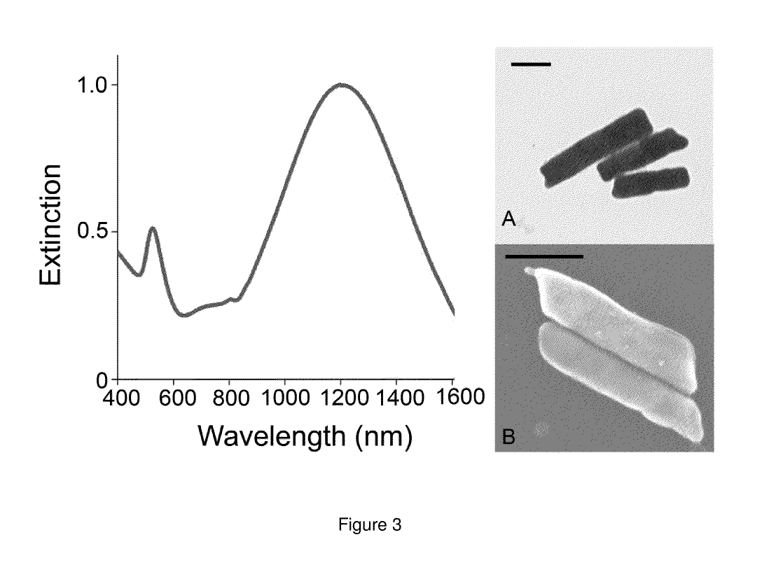

The liberated gold nanotubes can be suspended in deionized water or deuterium oxide by gentle ultrasonication. In a typical synthesis, the gold shell has a length in range of about 200 nm to about 300 nm, a width of about 30 nm to about 70 nm, and a thickness of about 15 nm (FIGS. 2 and 3), though gold shells of other dimensions are possible, as well. By careful selection of the sacrificial base metals and polymer core, this synthesis allows for hollow gold nanotubes to be later released into solution. Nickel was chosen as the base to support polymerization because it can be selectively etched from the gold tubes, and has a sufficiently high work function to support oxidative polymerization, though other materials may be equivalently used including but not limited to platinum, palladium, iron, manganese, titanium, titanium oxide, chromium, chromium oxide, zinc, zinc oxide, indium, tin, indium tin oxide, cadmium, selenium, tellurium, germanium, rhodium, ruthenium, iridium, calcium, aluminum or any metal with a high work function. A hydrophobic polymer, poly(3-hexylthiophene), was chosen as the polymer core, though other similar hydrophobic polymers may equivalently be used including, but not limited to, polyphenylene, polyethylene, polythiophene, poly-3-methylthiophene, polystyrene, polymethylmethacrylate, polyisoprene, polypropylene, or any other polymer that can be deposited into a porous membrane. This polymer core contracts when exposed to the aqueous gold plating solution, allowing space for gold nanotube growth without resorting to template etching methods.

Anisotropic particles such as rods or tubes are expected to exhibit two characteristic extinctions corresponding to the transverse and longitudinal plasmon modes. Transverse modes typically appear in the visible spectrum (about 350 nm to about 750 nm) and are related to particle radius, while longitudinal modes appear in the far red-to-near IR spectrum (about 750 nm to about 100 μm) and vary with the radius and aspect ratio.

Using the disclosed method of gold nanotube synthesis, it is possible to study the SPR response of gold nanotubes both as an aligned array in the template and as a suspension in e.g. D₂O, Studying aligned nanotubes sets the incident light angle parallel to the length of the nanostructures, and allows for the study of the transverse mode independent of the longitudinal mode. To leave only gold nanotubes aligned in the template, the copper, silver and nickel layers were dissolved and the polymer core was etched. Prior to absorption spectrometry, the template was mounted on a glass slide, and wetted with water to increase the transparency of the AAO matrix. In this particular example, a single peak at λ=553 nm was observed (FIG. 2) and corresponds to the transverse plasmon mode of the nanotube.

The optical properties of homogeneous solutions of gold nanotubes were also studied. Gold nanostructures aggregate in solution; however, brief ultrasonication immediately before measurement is sufficient to prevent aggregation at dilute concentrations, though other means of disaggregating the nanostructures may also be employed.

The following examples are presented to enable those skilled in the art to understand and to practice embodiments of the present disclosure. They should not be considered as a limitation on the scope of the present embodiments, but merely as being illustrative and representative thereof.

### Example 1

The following example illustrates an exemplary method for the synthesis and study of suspendable gold nanotubes.

Symmetric AAO membranes (13 mm diameter, 35 and 55 nm pore diameter) were purchased from Synkera Technologies Inc. Copper plating solution consisted of 0.95 M CuSO₄. 5H₂O, 0.21 M H₂SO₄. Nickel plating solution (Watts Nickel Pure) and gold plating solution (Orotemp 24 RTU) were purchased from Technic Inc. and used as received. 3-Hexylthiophene was purchased from Sigma Aldrich and distilled before use. Boron trifluoride diethyletherate (BF₃.Et₂O; >46% BF₃), 3-hexylthiophene, Glycerol and Deuterium Oxide (99.8% d) were purchased from Sigma-Aldrich and used as received. Silver metal was purchased from Kurt J. Leskar Materials group and used as received. All other chemicals were purchased from Fisher Scientific and used as received. All aqueous solutions were prepared using water from Millipore (18.2 MΩ·cm) filtration system. All electrochemical experiments were conducted using a BASi EC epsilon potentiostat.

150 nm of silver (99.9%) was deposited on one side of a membrane to serve as a working electrode using an Angstrom Engineering CoVap 2 evaporator. Silver was initially deposited at a rate of 0.08 nm/s. Once a thickness of 100 nm was reached, the deposition rate was increased to 0.15 nm/s until the final thickness (150 nm) was achieved.

The silver-coated membrane was placed silver side down on a piece of aluminum foil connected to the working electrode. A Viton O-ring (9 mm dia.) was placed on the top of the membrane to seal the electrochemical cell and define the working electrode area (64 mm2). An Ag/AgCl reference electrode was used for all metal deposition in aqueous solutions, and an Ag/AgNO₃ reference electrode was used for electropolymerization in BF₃.Et₂O. In all cases a Pt wire auxiliary electrode was used. Cu was deposited at −90 mV versus Ag/AgCl for 15 minutes using 3.0 mL of copper plating solution. Ni was deposited at −900 mV versus Ag/AgCl for 15 minutes using 3.0 mL of Ni plating solution. Cells were thoroughly rinsed with water and dried before being transferred to an inert atmosphere glove-box. Polymer nanowire cores were electropolymerized at +1500 mV vs. Ag/AgNO₃ for 10 minutes using 3.0 mL of a 7.5 mM monomer (3-hexylthiophene) solution in BF₃.Et₂O, followed by thorough rinsing with acetonitrile, ethanol, and water. To deposit gold nanotubes around the polymer core, the cell was dried, 3.0 mL of Au plating solution was added, and a potential (−920 mV versus Ag/AgCl) was applied for various times to control the length. Following gold deposition the cell was rinsed with water and dried.

The membranes were soaked in concentrated HNO₃ for 2 hours to dissolve the Ag, Cu and Ni layers, then rinsed with water. To dissolve the polymer core, the membranes were soaked in a piranha solution (3:1 H₂SO₄:H₂O₂) for 6-12 hours. After this treatment the template contains only gold nanotubes and appears purple. To liberate free nanotubes the template was immersed in 1.5 mL of a 3.0 M NaOH solution and shaken at 40° C. for 60 minutes. The nanostructures were purified by 4 successive centrifugation (16100 rcf, 15 min), supernatant removal, resuspension (D₂O) cycles.

All spectroscopy experiments were performed using a Varian Cary 5000 UV/vis/NIR spectrophotometer in D₂O scanning at room temperature from 400-1800 nm, using a D₂O reference as a baseline.

The suspended nanostructures (5 μL) were pipetted onto a carbon-coated copper TEM grid and allowed to dry. TEM images were obtained using a Hitachi H-7000 at an accelerating voltage of 100 kV. SEM images were obtained using a Hitachi S-5200 at accelerating voltages between 2 and 30 kV. For the length and width analysis >50 nanostructures were measured.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

Therefore what is claimed is:

1. A gold tube free of a supporting metal substrate, and having an outer diameter of between 1 nm and 2500 nm.

2. A tube of claim 1, wherein the tube wall defines an open passage from end to end of the tube.

3. The tube of claim 2, wherein the tube is a nanotube having a diameter of up to 100 nm.

4. The tube of claim 2, wherein the tube has a length in the range of from 1 nm to 10,000 nm.

5. The tube of claim 4, dimensioned to have an aspect ratio of at least 2.

6. The tube of claim 5, wherein the tube has a length of up to 1000 nm.

7. The tube of claim 6, wherein tube wall has a thickness in the range of from 1 nm to 100 nm.

8. The tube of claim 7, wherein the tube has a length of between 50 and 250 nm and an optical extinction peak in the range of about 400 nm to about 2000.

9. The tube of any of claim 1, further comprising a binder bound to the wall of the tube, wherein the binder is capable of binding to a biomolecule.

10. The tube of claim 11, wherein said biomolecule is selected from the group consisting of a nucleic acid molecule, a lipid, a polypeptide, DNA, RNA, aptamer and antibody.

11. The tube of claim 10, wherein the tube has a first surface plasmon resonance peak when the biomolecule is not bound to the binder and the tube has a second surface plasmon resonance peak when the biomolecule is bound to the binder, said second surface plasmon resonance peak being distinct from said first surface plasmon resonance peak.

12. A composition comprising a plurality of the tubes of claim 1, wherein each of the tubes is detached from the others.

13. A composition comprising a plurality of the tubes of claim 1, wherein the tubes are embedded in the matrix of a polymer, or suspended in a liquid solution.

14. A composition comprising a suspension of such nanotubes of claim 1, wherein the nanotubes exhibit a surface plasmon resonance peak in a range from 100 nm/RIU to 20,000 nm/RIU.

15. A method for synthesizing a gold tube, the method comprising:
a) providing a template comprising a mold having a pore therethrough and an electrode comprising a first layer providing a sacrificial contact surface at a first end of the pore;
b) electropolymerizing a polymer precursor to form a polymer core, the core walls defining a void interior of the core, in the pore;
c) collapsing the walls of the core into the void and away from walls of the pore to form a cavity defined between the walls of the core and the pore; and
d) introducing a gold plating solution into the cavity and electrodepositing gold onto the contact surface and forming the tube within the cavity.

16. The method of claim 15, wherein the polymer core comprises a polymer having a water contact angle greater than 70°.

17. The method of claim 16, wherein the polymer comprises poly(3-(C₁-C₃₀-alkylthiophene), poly(3,4-ethylenedioxythiophene), poly(3,4-methylenedioxythiophene), poly(3,4-propylenedioxythiophene), poly(3,4-dimethoxyoxythiophene), poly(3-hexylthiophene), polyphenylene, polythiophene, poly-3-methylthiophene, polyethylene, polystyrene, polymethylmethacrylate, polyisoprene, or polypropylene.

18. The method of claim 16, wherein the cavity formed in step c) is sufficiently wide to permit the step of forming the tube within the cavity.

19. The method of claim 18, wherein step d) is conducted subsequent to step c) without widening of the pore by etching of the pore walls between steps c) and d).

20. The method of claim 16, wherein the mold comprises a material selected from the group of materials consisting of anodized aluminum oxide, track-etched polycarbonate, track-etched polyester, mica, porous silica, porous metal oxides, and porous metals.

21. The method of claim 20, wherein the first layer comprises nickel, copper, platinum, palladium, iron, manganese, titanium, titanium oxide, chromium, chromium oxide, zinc, zinc oxide, indium, tin, indium tin oxide, cadmium, selenium, tellurium, germanium, rhodium, ruthenium, iridium, calcium, aluminum, or an oxide of any of the foregoing.

22. The method of claim 21, wherein the electrode comprises a second layer beneath the first layer and in electrical connection therewith.

23. The method of claim 22, wherein the second layer comprises silver.

24. The method of claim 27, wherein the first and second layers are in direct contact with each other.

25. The method of 23, wherein the electrode comprises an intervening electrical conductive layer between and in direct contact with the first and second layers.

26. The method of claim 25, wherein the intervening layer comprises nickel, copper, platinum, palladium, iron, manganese, titanium, titanium oxide, chromium, chromium oxide, zinc, zinc oxide, indium, tin, indium tin oxide, cadmium, selenium, tellurium, germanium, rhodium, ruthenium, iridium, calcium, aluminum, or an oxide of any of the foregoing, and first and intervening layers are different from each other.

27. The method of claim 26, wherein the first layer is nickel and the intervening layer is copper.

28. The method of claim 15, wherein step a) includes installing the electrode on the mold.

29. The method of claim 28, wherein installing the electrode includes depositing the second layer on an exterior surface of the mold in a location to form an interior surface at a first end of the pore.

30. The method of claim 29, wherein installing the electrode includes depositing the intervening layer onto the interior surface of the second layer, and depositing on the first layer onto the intervening layer.

31. The method of claim 16, further comprising the steps of removing the first layer, the polymer core and the mold to release the tube as a freely suspendable tube by chemically degrading the first layer, the polymer core and the mold under conditions to which the gold tube is chemically resistant.

32. A method for synthesizing a gold suspendable nanotube, the method comprising:
i) providing a template comprising a mold comprising anodized aluminum oxide as a first sacrificial material, the mold having a pore therethrough, the pore having an inner diameter of less than about 500 nm, an electrode comprising a nickel layer located to provide a sacrificial contact surface at a lower interior end of the pore, a copper layer underlying the nickel layer, and a silver working electrode underlying the copper layer;
ii) electropolymerizing a polymer precursor on the nickel layer to form a polymer core, the polymer having a water contact angle of greater than about 70° and core having an inner wall surface defining a void interior of the core, in the pore;
iii) contracting the polymer and causing the core to radially shrink away from the wall of the pore by a hydrophic effect caused by exposure to an aqueous solution to form a cavity defined between the outer wall of the core and the pore wall;
iv) electrodepositing gold onto the contact surface and forming the nanotube within the cavity; and
v) removing the nickel, copper, silver, polymer core, and aluminum oxide to form the nanotube.

33. A method for determining the presence of a biomolecule in a solution, the method comprising:
measuring an extinction spectrum of a gold nanotube as defined by claim 9 suspended in the solution to obtain a first extinction spectrum, wherein the molecule bound to the nanotube binds to the molecule when present; and
comparing the measured extinction spectrum to a second extinction spectrum of the nanotube, the second extinction spectrum being determined in the absence of the biomolecule,
wherein a substantial difference between the first and second extinction spectra indicates the presence of said biomolecule in said solution.

34. A method for determining the presence of a biomolecule in a solution, the method comprising:
measuring an electronic signature of a gold nanotube as defined by claim 9 suspended in the solution to obtain a first electronic signature, wherein the molecule bound to the nanotube binds to the molecule when present; and
comparing the measured electronic signature to a second electronic signature of the nanotube, the second electronic signature being determined in the absence of the biomolecule,
wherein a substantial difference between the first and second electronic signatures indicates the presence of said biomolecule in said solution.

35. An electrochemical sensor comprising an electrode wherein the electrode comprises a tube as defined by claim 1.

36. A battery electrode comprising a tube as defined by claim 1.

37. An electrochemical capacitor comprising an electrode wherein the electrode comprises a tube as defined by claim 1.
